(19) United States
(12) Patent Application Publication
(10) Pub. No.: US 2007/0057491 A1
(43) Pub. Date: Mar. 15, 2007

(54) Vehicle occupant protection apparatus located in the door of a vehicle

(75) Inventor: Gregory S. Bayley, Dryden, MI (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Vehicle Safety Systems Inc.

(21) Appl. No.: 11/222,530

(22) Filed: Sep. 9, 2005

(51) Int. Cl. B60R 21/21

(52) U.S. Cl. 280/730.2; 280/742

(57) ABSTRACT

An occupant protection apparatus (64) for a vehicle (10) includes a chamber (80) formed within a member (30) of a frame portion (24) of a door (12). An inflatable occupant protection device (66) is stored within the chamber (80). The protection device (66), in response to receiving inflation fluid, inflates out of the chamber (80) and into a position for helping to protect an occupant (76) of the vehicle (10). An inflator (124) is located within the door (12) at a location remote from the protection device (66). The inflator (124) is actuatable for providing inflation fluid for inflating the protection device (66). The apparatus (64) also includes a conduit (126) for receiving inflation fluid from the inflator (124) and for providing the inflation fluid to the protection device (66).

### TECHNICAL FIELD

The present invention relates to a vehicle occupant protection apparatus. More particularly, the present invention relates to an inflatable vehicle occupant protection apparatus that, in a deflated and stored condition, is located in the door of a vehicle.

### BACKGROUND OF THE INVENTION

It is known to inflate an inflatable vehicle occupant protection apparatus within the passenger compartment of a vehicle and adjacent to the side structure of the vehicle in response to the detection of a side impact to the vehicle. One particular type of inflatable vehicle occupant protection apparatus that is inflated in response to the detection of a side impact is an inflatable curtain. Typically, an inflatable curtain is housed adjacent a roof rail of the vehicle. The inflatable curtain, in response to receiving inflation fluid, inflates downwardly into a position between an occupant of the vehicle and the side structure of the vehicle.

It is also known to store an inflatable vehicle occupant protection apparatus for inflating into a position adjacent the side structure of the vehicle within the door or within the seat of the vehicle. Typically, when stored in the door, the inflatable vehicle occupant protection apparatus is located behind the trim that is attached to the panel portion of the door. In response to receiving inflation fluid, the inflatable vehicle occupant protection apparatus inflates upwardly into a position between the occupant and the side structure of the vehicle for helping to protect the occupant of the vehicle.

It is also known to use a fill tube to direct inflation fluid from an inflator to an inflatable curtain. A fill tube typically is an elongated conduit having one end connected to a fluid outlet of the inflator and an opposite end located in the inflatable curtain. Inflation fluid flows through the fill tube and into the inflatable curtain.

### SUMMARY OF THE INVENTION

The present invention relates to an occupant protection apparatus for a vehicle. The apparatus comprises a chamber formed within a member of a frame portion of a door. The apparatus also comprises an inflatable occupant protection device stored within the chamber. The inflatable occupant protection device, in response to receiving inflation fluid, inflates out of the chamber and into a position for helping to protect an occupant of the vehicle. An inflator is located within the door at a location remote from the inflatable occupant protection device. The inflator is actuatable for providing inflation fluid for inflating the inflatable occupant protection device. The apparatus further comprises a conduit for receiving inflation fluid from the inflator and for providing the inflation fluid to the inflatable occupant protection device.

### BRIEF DESCRIPTION OF THE DRAWINGS

The foregoing and other features of the present invention will become apparent to those skilled in the art to which the present invention relates upon reading the following description with reference to the accompanying drawings, in which:

FIG. 1 schematically illustrates a portion of a vehicle including a front driver-side door and portions of an apparatus constructed in accordance with the present invention;

FIG. 2 is a view of an apparatus constructed in accordance with a first embodiment of the present invention and in a deflated and stored condition within the door;

FIG. 3 is a view taken along line 3-3 of FIG. 2;

FIG. 4 is a view taken along line 4-4 of FIG. 2;

FIG. 5 is a view of the apparatus of FIG. 2 located in a door having a construction that differs from the door of FIGS. 1 and 2;

FIG. 6 schematically illustrates a portion of a vehicle including a rear driver-side door and portions of an apparatus constructed in accordance with the present invention;

FIG. 7 is a view of an apparatus constructed in accordance with a second embodiment of the present invention and in a deflated and stored condition within the door; and `

FIGS. 8 and 9 are sectional views illustrating portions of the apparatus of FIG. 7 located in the door and adjacent to a structural member of the vehicle.

### DETAILED DESCRIPTION OF THE INVENTION

FIG. 1 schematically illustrates a portion of a vehicle 10 including a front driver-side door 12. The door 12 is located laterally adjacent to a driver's seat 14 of the vehicle 10 and, when closed, is interposed between the A-pillar 16 and the B-pillar 18 of the vehicle.

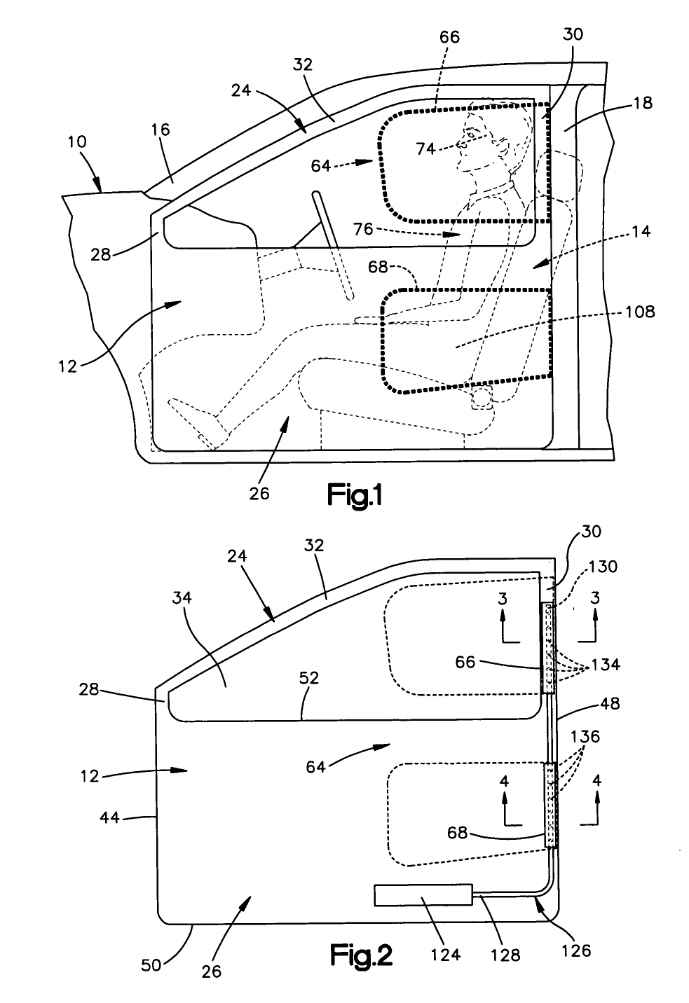

The door 12 includes a frame portion 24 and a panel portion 26. The frame portion 24 of the door 12 is located immediately above the panel portion 26 of the door. The frame portion 24 includes a relatively short, vertically extending front member 28 and a relatively long, vertically extending rear member 30. The rear member 30 of the door 12 illustrated in FIG. 2 is approximately five times longer than the front member 28 of the door. The frame portion 24 also includes an upper member 32 that connects an upper end of the front member 28 to an upper end of the rear member 30. A window 34, when raised, is located in the frame portion 24 of the door 12.

As is shown in FIG. 4, the panel portion 26 of the door 12 includes an exterior panel 40 and an interior panel 42. A front wall (not shown) connects the exterior and interior panels 40 and 42 at a front end 44 (FIG. 2) of the door 12. A rear wall 46 (FIG. 4) connects the exterior and interior panels 40 and 42 at a rear end 48 (FIG. 2) of the door 12. As shown in FIG. 2, the panel portion 26 of the door 12 extends vertically from a lower edge 50 to an upper edge 52.

As shown in FIG. 4, a hollow cavity 58 is located within the panel portion 26 of the door 12. The cavity 58 separates the exterior and interior panels 40 and 42. Sound deadening material (not shown), structural supports (not shown), and mechanisms (not shown) for operating latches of the door 12 and for lowering and raising the window 34 of the door are located within the cavity 58. Also, when the window 34 of the door 12 is lowered, the window 34 is received in the cavity 58 of the panel portion 26 of the door 12.

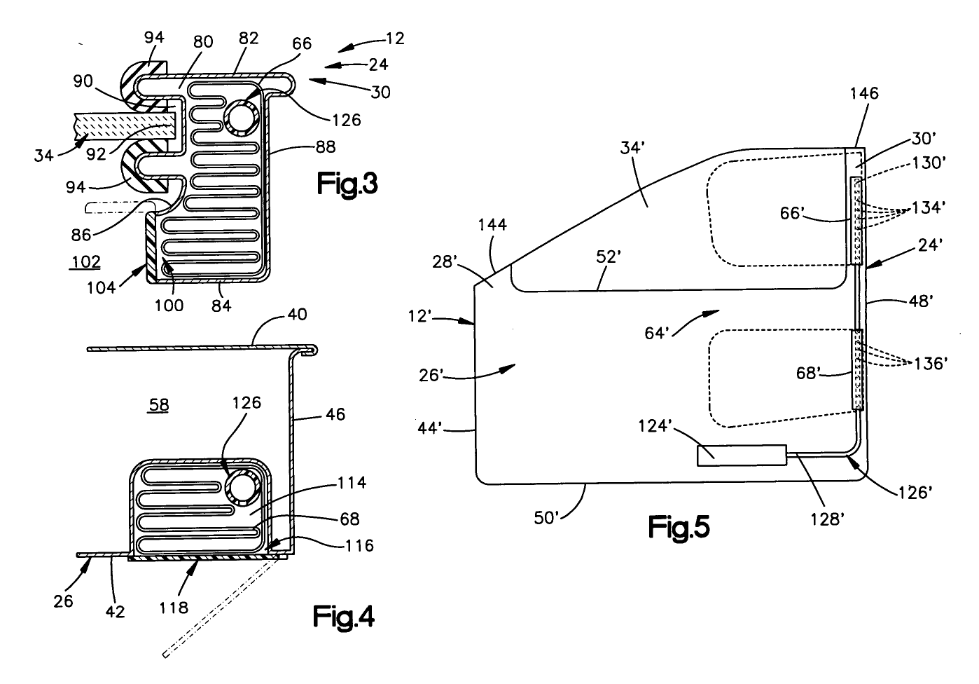

FIG. 2 illustrates an apparatus 64 constructed in accordance with a first embodiment of the present invention. The apparatus 64 includes first and second air bags 66 and 68, respectively. The first air bag 66 is associated with the head 74 of an occupant 76 of the vehicle 10 and is inflatable into a position located generally between the head of the occupant and the window 34 of the door 12, as shown by the dashed line labeled 66 in FIG. 1. The first air bag 66, when in a deflated and stored condition is located within a chamber 80 formed in the rear member 30 of the frame portion 24 of the door 12, as is shown in FIG. 3.

As FIG. 3 illustrates, the rear member 30 of the frame portion 24 of the door 12 includes an exterior wall portion 82, an interior wall portion 84, a front wall portion 86, and a rear wall portion 88. The chamber 80 is located within the rear member 30 and is defined by the exterior, interior, front, and rear wall portions 82, 84, 86, and 88, respectively. The chamber 80 extends vertically through the rear member 30 and connects with the cavity 58 of the panel portion 26 of the door 12 at the location at which the rear member 30 of the frame portion 24 of the door and the panel portion of the door meet.

The exterior and interior wall portions 82 and 84 of the rear member 30 are generally planar and extend parallel to one another. The rear wall portion 88 of the rear member 30 connects the exterior and interior wall portions 82 and 84. A seal (not shown) may be adhered to the rear wall portion 88 for sealing against a portion of the B-pillar 18 (FIG. 1) of the vehicle 10 when the door 12 is closed.

The front wall portion 86 of the rear member 30 is bent to form a pocket 90 for receiving an edge 92 of the window 34. FIG. 3 illustrates two seals 94 adhered to the front wall portion 86 and also illustrates the edge 92 of the window 34 being received in the pocket 90. An opening 100 is located in the front wall portion 86 of the rear member 30 at a location adjacent the interior wall portion 84. As shown in FIG. 3, the opening 100 is located in the front wall portion 86 at a location internal to the vehicle compartment, shown generally at 102, relative to the window 34. In addition to extending horizontally, as shown in FIG. 3, the opening 100 extends vertically along the rear member 30 of the frame portion 24 of the door 12 over a distance greater than the vertical extent of the first air bag 66 when in the deflated and stored condition within the chamber 80, shown in FIG. 2.

As shown in FIG. 3, a cover 104 closes the opening 100 in the front wall portion 86 of the rear member 30. The cover 104 may extend over only the opening 100, as is shown in FIG. 3, or may be formed in a trim component (not shown) that also covers the interior wall portion 84 of the rear member 30. The cover 104 is designed to pivot from a closed condition, shown by solid lines in FIG. 3, to an open condition, shown by dot-dashed lines in FIG. 3, in response to the first air bag 66, while being inflated, pressing against the cover.

The second air bag 68 is associated with the pelvis or lower torso 108 (FIG. 1) of the occupant 76 and is inflatable into a position located generally between the lower torso of the occupant 76 and the panel portion 26 of the door 12, as shown by the dashed line 68 labeled in FIG. 1. The second air bag 68, when in a deflated and stored condition, is located within a chamber 114 that is formed in the panel portion 26 of the door 12, as is shown in FIG. 4.

As FIG. 4 illustrates, the rear wall 46 of the panel portion 26 connects the exterior and interior panels 40 and 42 of the panel portion 26 of the door 12 at the rear edge 48 (FIG. 2) of the door. A seal (not shown) may be adhered to the rear wall 46 for sealing against a portion of the B-pillar 18 of the vehicle 10 when the door 12 is closed. As shown in FIG. 4, a portion of the interior panel 42, at a location adjacent the rear wall 46, extends toward the exterior panel 40 so as to form the chamber 114 for the second air bag 68. The chamber 114 includes upper and lower ends (not shown), each of which is open into the cavity 58 of the panel portion 26 of the door 12. An opening 116 to the chamber 114 extends horizontally, as shown in FIG. 4, and also extends vertically along the interior panel 42 of the panel portion 26 of the door 12 over a distance greater than the vertical extent of the second air bag 68 when in the deflated and stored condition within the chamber 114, shown in FIG. 2.

As shown in FIG. 4, a cover 118 closes the opening 116 to the chamber 114. The cover 118 may extend over only the opening 116, as is shown in FIG. 4, or may be formed in a trim component (not shown) that covers the interior panel 42 of the door 12. The cover 118 is designed to pivot from a closed condition, shown by solid lines in FIG. 4, to an open condition, shown by dot-dashed lines in FIG. 4, in response to the second air bag 68, while being inflated, pressing against the cover.

The apparatus 64 of the present invention also includes an inflator 124 (FIG. 2). The inflator 124 is actuatable for providing inflation fluid for inflating the first and second air bags 66 and 68. The inflator 124 may include a stored quantity of pressurized inflation fluid and an ignitable material for heating the inflation fluid. Alternatively, the inflator 124 may include a combustible gas generating material, a stored quantity of pressurized inflation fluid, or any other source for providing inflation fluid.

The inflator 124 is located within the cavity 58 of the panel portion 26 of the door 12 at a location remote from both the first and second air bags 66 and 68. In the embodiment illustrated in FIG. 2, the inflator 124 is located adjacent the lower edge 50 of the panel portion 26 of the door 12. As a result, the inflator 124 is located below the window 34 of the door 12 when the window is lowered into the cavity 58 of the panel portion 26 of the door. A mounting bracket (not shown) may be used for securing the inflator 124 to the door 12.

The apparatus 64 also includes a conduit 126 for directing inflation fluid from the inflator 124 to the first and second air bags 66 and 68. As shown in FIG. 2, the conduit 126 is generally L-shaped and has opposite first and second ends 128 and 130, respectively. The first end 128 of the conduit 126 connects to a fluid outlet of the inflator 124. The second end 130 of the conduit 126 is located within the first air bag 66. The conduit 126 includes first and second series of holes 134 and 136, respectively. The first series of holes 134 is associated with the first air bag 66 and the second series of holes 136 is associated with the second air bag 68.

The conduit 126 extends from the inflator 124 through the chamber 114 in the panel portion 26 of the door 12 and into the chamber 80 in the rear member 30 of the frame portion 24 of the door. When the apparatus 64 is assembled into the door 12, the portion of the conduit 126 having the first series of holes 134 is located within the first air bag 66 in the chamber 80 and the portion of the conduit 126 having the second series of holes 136 is located within the second air bag 68 in the chamber 114.

Upon the occurrence of a crash condition for which inflation of the first and second air bags 66 and 68 is desired, the inflator 124 is actuated to provide inflation fluid. Inflation fluid exiting the inflator 124 enters the first end 128 of the conduit 126. The inflation fluid flows through the conduit 126 and exits the conduit through the first and second series of holes 134 and 136.

Inflation fluid exiting the conduit 126 through the first series of holes 134 is received in the first air bag 66. In response to receiving inflation fluid, the first air bag 66 begins to inflate. As the first air bag 66 inflates, the first air bag 66 presses against the cover 104. The force of the first air bag 66 pressing against the cover 104 moves the cover from the closed condition to the open condition. When the cover 104 is in the open condition, the first air bag 66 may deploy through the opening 100 in the rear member 30 and into a position between the head 74 of the occupant 76 and the window 34, as shown in FIG. 1. During inflation, the first air bag 66 inflates in a generally horizontal direction toward the front of the vehicle 10.

Inflation fluid exiting the conduit 126 through the second series of holes 136 is received in the second air bag 68. In response to receiving inflation fluid, the second air bag 68 begins to inflate. As the second air bag 68 inflates, the second air bag 68 presses against the cover 118. The force of the second air bag 68 pressing against the cover 118 moves the cover from the closed condition to the open condition. When the cover 118 is in the open condition, the second air bag 68 may deploy through the opening 116 and into a position between the lower torso 108 of the occupant 76 and the panel portion 26 of the door 12, as shown in FIG. 1. During inflation, the second air bag 68 inflates in a generally horizontal direction toward the front of the vehicle 10.

FIG. 5 is a view of the apparatus 64′ located in a door 12′ having a construction that differs from the door 12 of FIGS. 1 and 2. The apparatus 64′ illustrated in FIG. 5 is identical to the apparatus 64 shown and described with reference to FIGS. 2-4. The features of the door 12′ and the apparatus 64′ illustrated in FIG. 5 that are the same as or similar to those discussed with reference to FIGS. 2-4 are numbered with the same reference numbers with the addition of a prime.

The door 12′ illustrated in FIG. 5 is commonly referred to as a stub frame door. Stub frame doors are common in convertibles. In a stub frame door 12′, the frame portion 24′ of the door 12′ does not extend completely around the window 34′. As shown in FIG. 5, the frame portion 24′ of the door 12′ does not include an upper member that connects the front and rear members 28′ and 30′ and that, when the window 34′ is raised, extends above the window. Instead, the front member 28′ of the door 12′ terminates at an upper end 144 and the rear member 30′ of the door terminates at an upper end 146.

Like the rear member 30 of the frame portion 24 illustrated in FIG. 3, a chamber (not shown) is located in the rear member 30′ of the frame portion 24′ of the stub frame door 12′. The chamber in the rear member 30′ of the stub frame door 12′ is located below the upper end 146 of the rear member. An opening (not shown), which may be closed by a rupturable or pivotal cover (not shown), extends through the rear member 30′. The first air bag 66′ and the portion of the conduit 126′ having the first series of holes 134′ are located in the chamber near the opening. The panel portion 26′ of the stub frame door 12′ is identical to the panel portion 26 of the door 12 discussed with reference to FIGS. 1, 2, and 4. The apparatus 64′ of FIG. 5 operates in the same manner as the apparatus 64 of FIGS. 2-4 for inflating the first and second air bags 66′ and 68′ from deflated and stored conditions, shown by solid lines in FIG. 5, to inflated conditions, shown by dashed lines in FIG. 5.

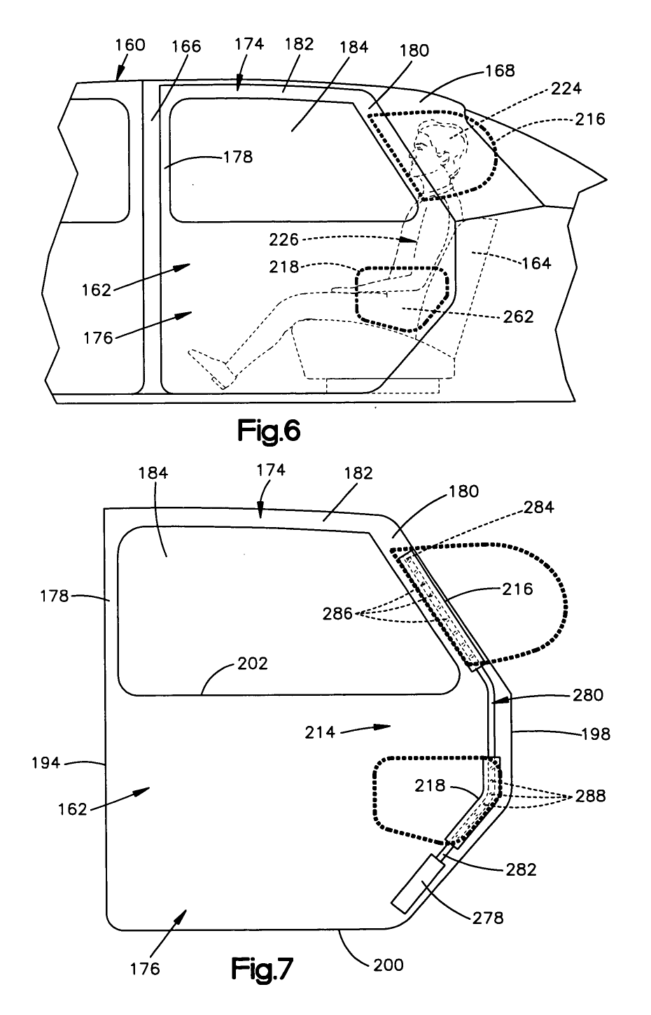

FIG. 6 schematically illustrates a portion of a vehicle 160 including a rear driver-side door 162. The door 162 is located laterally adjacent to a rear driver-side seat 164 of the vehicle 160 and, when closed, is interposed between the B-pillar 166 and the C-pillar 168 of the vehicle 160.

The door 162 includes a frame portion 174 and a panel portion 176. The frame portion 174 of the door 162 is located immediately above the panel portion 176 of the door. The frame portion 174 includes a vertically extending front member 178 and a rear member 180 that extends toward the front member as it extends vertically upward. The front and rear members 178 and 180 of the door 162 extend vertically over approximately equal distances. The frame portion 174 of the door 162 also includes an upper member 182 that extends horizontally between and connects upper ends of the front and rear members 178 and 180. A window 184, when raised, is located in the frame portion 174 of the door 162.

As is shown in FIG. 9, the panel portion 176 of the door 162 includes an exterior panel 190 and an interior panel 192. A front wall (not shown) connects the exterior and interior panels 190 and 192 at a front edge 194 (FIG. 7) of the door 162. A rear wall 196 (FIG. 9) connects the exterior and interior panels 190 and 192 at a rear edge 198 (FIG. 7) of the door 162. As shown in FIG. 7, the panel portion 176 of the door 162 extends vertically from a lower edge 200 to an upper edge 202.

As shown in FIG. 9, a hollow cavity 210 is located within the panel portion 176 of the door 162. The cavity 210 separates the exterior and interior panels 190 and 192. Sound deadening material (not shown), structural supports (not shown), and mechanisms (not shown) for operating latches of the door 162 and for lowering and raising the window 184 of the door are located within the cavity 210. Also, when the window 184 of the door 162 is lowered, the window 184 is received in the cavity 210 of the panel portion 176 of the door 162.

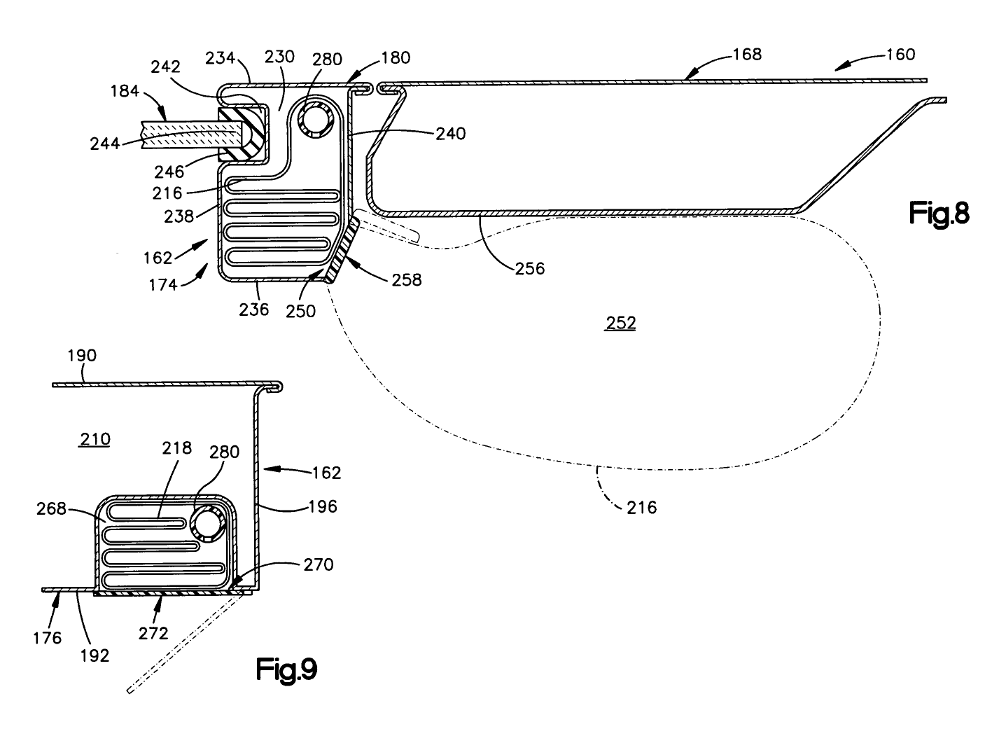

FIG. 7 illustrates an apparatus 214 constructed in accordance with a second embodiment of the present invention. The apparatus 214 includes first and second air bags 216 and 218, respectively. The first air bag 216 is associated with the head 224 of an occupant 226 of the vehicle 160 and is inflatable into a position located generally between the head of the occupant and the C-pillar 168 of the vehicle, as shown in FIG. 6. The first air bag 216, when in a deflated and stored condition is located within a chamber 230 formed in the rear member 180 of the frame portion 174 of the door 162, as is shown in FIG. 8.

As FIG. 8 illustrates, the rear member 180 of the frame portion 174 of the door 162 includes an exterior wall portion 234, an interior wall portion 236, a front wall portion 238, and a rear wall portion 240. The chamber 230 is located within the rear member 180 and is defined by the exterior, interior, front, and rear wall portions 234, 236, 238, and 240, respectively. The chamber 230 connects with the cavity 210 of the panel portion 176 of the door 162 at the location at which the rear member 180 of the frame portion 174 of the door and the panel portion of the door meet.

The exterior and interior wall portions 234 and 236 of the rear member 180 are generally planar and extend parallel to one another. The front wall portion 238 of the rear member 180 connects the exterior and interior wall portions 234 and 236. The front wall portion 238 of the rear member 180 is bent at a location adjacent the exterior wall portion 234 so as to form a pocket 242 for receiving an edge 244 of the window 184. FIG. 8 illustrates a U-shaped seal 246 that is adhered to the front wall portion 238 within the pocket 242 and also illustrates the edge 244 of the window 184 being received by the seal 246 and the pocket 242. A seal (not shown) may be adhered to the rear wall portion 240 of the rear member 180 for sealing against a portion of the C-pillar 168 of the vehicle 160 when the door 162 is closed. As FIG. 8 illustrates, the rear wall portion 240 is located immediately adjacent the C-pillar 168 when the door 162 is closed.

An opening 250 is located in the rear wall portion 240 of the rear member 180 at a location adjacent the interior wall portion 236. As shown in FIG. 8, the opening 250 is located in the rear wall portion 240 at a location internal the vehicle compartment 252 relative to an interior wall 256 of the C-pillar 168. In addition to extending horizontally., as illustrated in FIG. 8, the opening 250 in the rear wall portion 240 of the rear member 180 extends vertically over a distance greater than the vertical extent of the first air bag 216 when in the deflated and stored condition within a chamber 230, shown in FIG. 7.

As shown in FIG. 8, a cover 258 closes the opening 250. The cover 258 may extend over only the opening 250, as is shown in FIG. 8, or may be formed in a trim component (not shown) that also covers the interior wall portion 236 of the rear member 180. The cover 258 is designed to pivot from a closed condition, shown by solid lines in FIG. 8, to an open condition, shown by dot-dashed lines in FIG. 8, in response to the first air bag 216, while being inflated, pressing against the cover.

The second air bag 218 is associated with the pelvis or lower torso 262 (FIG. 6) of the occupant 226 and is inflatable into a position located generally between the lower torso of the occupant and the panel portion 176 of the door 162, as shown by the dashed line labeled 218 in FIG. 6. The second air bag 218, when in a deflated and stored condition is located within a chamber 268 that is formed in the panel portion 176 of the door 162, as is shown in FIG. 9.

As FIG. 9 illustrates, the rear wall 196 connects the exterior and interior panels 190 and 192 of the panel portion 176 of the door 162 at the rear edge 198 (FIG. 7) of the door. A seal (not shown) may be adhered to the rear wall 196 for sealing against a portion of the C-pillar 168 of the vehicle 160 when the door 162 is closed. As shown in FIG. 9, a portion of the interior panel 192 of the door 162, at a location adjacent the rear wall 196, extends toward the exterior panel 190 so as to form the chamber 268 for the second air bag 218. The chamber 268 includes upper and lower ends (not shown), each of which is open into the cavity 210 of the panel portion 176 of the door 162. An opening 270 to the chamber 268 extends horizontally, as shown in FIG. 9, and also extends vertically along the interior panel 192 of the panel portion 176 of the door 162 over a distance greater than the vertical extent of the second air bag 218 when in the deflated and stored condition within the chamber 268, shown in FIG. 7.

As shown in FIG. 9, a cover 272 closes the opening 270 to the chamber 268. The cover 272 may extend over only the opening 270, as is shown in FIG. 9, or may be formed in a trim component (not shown) that covers the interior panel 192 of the door 162. The cover 272 is designed to pivot from a closed condition, shown by solid lines in FIG. 9, to an open condition, shown by dot-dashed lines in FIG. 9, in response to the second air bag 218, while being inflated, pressing against the cover.

The apparatus 214 of the present invention also includes an inflator 278 (FIG. 7). The inflator 278 is actuatable for providing inflation fluid for inflating the first and second air bags 216 and 218. The inflator 278 may include a stored quantity of pressurized inflation fluid and an ignitable material for heating the inflation fluid. Alternatively, the inflator 278 may include a combustible gas generating material, a stored quantity of pressurized inflation fluid, or any other source for providing inflation fluid.

The inflator 278 is located within the cavity 210 of the panel portion 176 of the door 162 at a location remote from both the first and second air bags 216 and 218. FIG. 7 illustrates the inflator 278 located adjacent both the rear edge 198 and the lower edge 200 of the panel portion 176 of the door 162. As a result, the inflator 278 is located below the window 184 of the door 162 when the window is lowered into the cavity 210 of the panel portion 176 of the door. A mounting bracket (not shown) may be used for securing the inflator 278 to the door 162.

The apparatus 214 also includes a conduit 280 for directing inflation fluid from the inflator 278 to the first and second air bags 216 and 218. The conduit 280 has opposite first and second ends 282 and 284, respectively. The first end 282 of the conduit 280 connects to a fluid outlet of the inflator 278. The second end 284 of the conduit 280 is located within the first air bag 216. The conduit 280 includes first and second series of holes 286 and 288, respectively. The first series of holes 286 is associated with the first air bag 216 and the second series of holes 288 is associated with the second air bag 218.

The conduit 280 extends from the inflator 278 through the chamber 268 in the panel portion 176 of the door 162 and into the chamber 230 of the rear member 180 of the frame portion 174 of the door. When the apparatus 214 is assembled into the door 162, the portion of the conduit 280 having the first series of holes 286 is located within the first air bag 216 in the chamber 230 and the portion of the conduit 280 having the second series of holes 288 is located within the second air bag 218 in the chamber 268.

Upon the occurrence of a crash condition for which inflation of the first and second air bags 216 and 218 is desired, the inflator 278 is actuated to provide inflation fluid. Inflation fluid exiting the inflator 278 enters the first end 282 of the conduit 280. The inflation fluid flows through the conduit 280 and exits the conduit through the first and second series of holes 286 and 288.

Inflation fluid exiting the conduit 280 through the first series of holes 286 is received in the first air bag 216. In response to receiving inflation fluid, the first air bag 216 begins to inflate. As the first air bag 216 inflates, the first air bag 216 presses against the cover 258. The force of the first air bag 216 pressing against the cover 258 moves the cover from the closed condition to the open condition. When the cover 258 is in the open condition, the first air bag 216 may deploy through the opening 250 in the rear member 180 and into a position between the head 224 of the occupant 226 and the C-pillar 168 of the vehicle 160, as shown in FIG. 6. Dot-dashed lines in FIG. 8 also illustrate the first air bag 216 in an inflated condition adjacent the interior wall 256 of the C-pillar 168 of the vehicle 160. During inflation, the first air bag 216 inflates in a generally horizontal direction toward the rear of the vehicle 160.

Inflation fluid exiting the conduit 280 through the second series of holes 288 is received in the second air bag 218. In response to receiving inflation fluid, the second air bag 218 begins to inflate. As the second air bag 218 inflates, the second air bag 218 presses against the cover 272. The force of the second air bag 218 pressing against the cover 272 moves the cover from the closed condition to the open condition. When the cover 272 is in the open condition, the second air bag 218 may deploy through the opening 270 and into a position between the lower torso 262 of the occupant 226 and the panel portion 176 of the door 162, as shown in FIG. 6. During inflation, the second air bag 218 inflates in a generally horizontal direction toward the front of the vehicle 160.

From the above description of the invention, those skilled in the art will perceive improvements, changes and modifications. For example, the apparatus 64, 64′, or 214 may include a thorax bag. Additionally, the apparatus 64, 64′, or 214 may include only one air bag and need not include separate first and second air bags. Such improvements, changes and modifications within the skill of the art are intended to be covered by the appended claims.

Having described the invention, I claim the following:

1. An occupant protection apparatus for a vehicle, the apparatus comprising:
a chamber formed within a member of a frame portion of a door;
an inflatable occupant protection device stored within the chamber, the inflatable occupant protection device, in response to receiving inflation fluid, inflating out of the chamber and into a position for helping to protect an occupant of the vehicle;
an inflator located within the door at a location remote from the inflatable occupant protection device, the inflator being actuatable for providing inflation fluid for inflating the inflatable occupant protection device; and
a conduit for receiving inflation fluid from the inflator and for providing the inflation fluid to the inflatable occupant protection device.

2. The apparatus of claim 1 wherein the member of the frame portion of the door is a vertically extending member located at a rear end of the door.

3. The apparatus of claim 2 wherein the vehicle has a front end and a rear end and wherein an opening extends through a front wall of the member of the frame portion, the inflatable occupant protection device, in response to receiving inflation fluid, inflates through the opening and in a generally horizontal direction toward the front end of the vehicle.

4. The apparatus of claim 3 wherein a cover, when in a closed condition, closes the opening, the inflatable occupant protection device, while inflating, moving the cover from the closed condition to an open condition.

5. The apparatus of claim 4 wherein the door is a front door of the vehicle and wherein the inflatable occupant protection device, when inflated, is located adjacent to a window of the door for helping to protect a head of an occupant of the vehicle.

6. The apparatus of claim 2 wherein the vehicle has a front end and a rear end wherein an opening extends through a rear wall of the member of the frame portion, the inflatable occupant protection device, in response to receiving inflation fluid, inflates through the opening and in a generally horizontal direction toward the rear end of the vehicle.

7. The apparatus of claim 6 wherein a cover, when in a closed condition, closes the opening, the inflatable occupant protection device, while inflating, moving the cover from the closed condition to an open condition.

8. The apparatus of claim 7 wherein the door is a rear door of the vehicle and wherein the inflatable occupant protection device, when inflated, is located adjacent to a C-pillar of the vehicle for helping to protect a head of an occupant of the vehicle.

9. The apparatus of claim 1 wherein the inflator is located in a cavity located within a panel portion of the door, the conduit extending through the cavity and into the chamber in the member of the frame portion of the door.

10. The apparatus of claim 9 wherein the conduit includes series of holes through which inflation fluid exits the conduit, the series of holes being located in the inflatable occupant protection device in the chamber.

11. The apparatus of claim 1 wherein the chamber is a first chamber and the inflatable occupant protection device is a first inflatable occupant protection device, the apparatus further including a second chamber located in a panel portion of the door and a second inflatable occupant protection device stored within the second chamber, the second inflatable occupant protection device, in response to receiving inflation fluid, inflating out of the second chamber and into a position for helping to protect an occupant of the vehicle.

12. The apparatus of claim 11 wherein the second inflatable occupant protection device, when inflated, is located adjacent to the panel portion of the door for helping to protect a lower torso of an occupant of the vehicle.

13. The apparatus of claim 11 wherein the second chamber is formed by a portion of an interior panel of the panel portion of the door.

14. The apparatus of claim 11 wherein a cover, when in a closed condition, extends over an opening to the second chamber, the second inflatable occupant protection device, while inflating, moving the cover from the closed condition to an open condition.

15. The apparatus of claim 14 wherein the vehicle has a front end and a rear end and wherein the second inflatable occupant protection device, in response to receiving inflation fluid, inflates through the opening of the second chamber and in a generally horizontal direction toward the front end of the vehicle.

16. The apparatus of claim 11 wherein the inflator is located in a cavity located within the panel portion of the door, the conduit extending from the inflator, through the second chamber, and terminating in the first chamber.

17. The apparatus of claim 16 wherein the conduit includes first and second series of holes through which inflation fluid exits the conduit, the first series of holes located in the first inflatable occupant protection device in the first chamber and the second series of holes located in the second inflatable occupant protection device in the second chamber.
